(19) United States
(12) Patent Application Publication
(10) Pub. No.: US 2017/0301260 A1
(43) Pub. Date: Oct. 19, 2017

(54) SYSTEM AND METHOD FOR TEACHING A VEHICLE USER ABOUT VEHICLE FEATURES

(71) Applicant: FORD GLOBAL TECHNOLOGIES, LLC, Dearborn, MI (US)

(72) Inventors: Uwe GUSSEN, Huertgenwald NRW (DE); Frederic STEFAN, Aachen NRW (DE); Christoph ARNDT, Moerlen Rheinland-Pfalz (DE)

(73) Assignee: FORD GLOBAL TECHNOLOGIES, LLC, Dearborn, MI (US)

(21) Appl. No.: 15/488,861

(22) Filed: Apr. 17, 2017

(30) Foreign Application Priority Data
Apr. 15, 2016 (DE) 10 2016 206 372.3

(51) Int. Cl. G09B 19/16; G09B 7/00; G09B 5/04; G09B 5/02; G09B 19/14; G09B 5/06; G07C 5/02

(52) U.S. Cl. CPC G09B 19/167; G09B 19/14; G09B 7/00; G09B 5/06; G09B 5/04; G09B 5/02; G07C 5/02

(57) ABSTRACT

A method and a device to teach a vehicle user about features and functions of the vehicle using an electronic device located in the vehicle. The user is offered, by the electronic device, a catalogue of guided driving tutorials. Each of the guided driving tutorials includes a sequence of instructions to the user to pay attention to certain vehicle responses and/or to perform certain operating actions or driving maneuvers, and to pay attention to the corresponding response made by the vehicle or by vehicle components.

### CROSS-REFERENCE TO RELATED APPLICATIONS

This application claims foreign priority benefits under 35 U.S.C. §119(a)-(d) to DE Application 10 2016 206 372.3 filed Apr. 15, 2016, which is hereby incorporated by reference in its entirety.

### TECHNICAL FIELD

The disclosure relates to a method and device for getting a user of a vehicle to learn about features and functions of the vehicle using an electronic device located in the vehicle.

### BACKGROUND

EP 2 439 718 A1 discloses a method for computer-aided teaching of functions, operating principles and operation of vehicles such as, for example, aircraft, trains or utility vehicles, comprising: simulating vehicle features, behavior, results of interactions and fault scenarios; storing training material; setting the vehicle simulation to a predefined state for a training session; accepting a user input representing an interaction of a user with the vehicle; determining the effect of the interaction on the vehicle by the simulation; simulating the interaction and its effect on the vehicle; and influencing the simulation if the user does not adhere to a protocol for the training session.

CN 204 463 241 U discloses driver-training vehicle equipment, which is based on a Bluetooth function of a mobile terminal. The driver-training vehicle equipment consists of a fingerprint identification device, a Bluetooth communications device, a server communications device, a contact card reader, a contactless card reader, a handling device and a device for human-machine interaction.

http://greenroad.com/mobile-edition/discloses a driver safety and fleet management system for a mobile terminal, which converts the terminal into an in-vehicle driving trainer and trains drivers to correct immediately unsafe or inefficient behavior.

Many vehicle users do not know how to use all the features and functions of their vehicle, and are not even aware of many new features and functions. In addition, a vehicle dealer or rental agent often does not have the time to explain or demonstrate to a customer all the features and functions, and customers, especially older people, also cannot easily remember all this information.

Traditionally, the user can consult a thick manual to find the numerous features and functions implemented in his vehicle, although many drivers do this only reluctantly.

There are also electronic manuals and tutorial software that a vehicle user can access using a suitable electronic device, although there is the risk that the user does not correctly understand terminology used for vehicle parts, operating modes, features and driving maneuvers and is surprised by the vehicle's responses to a certain operating action.

These problems exist in particular because the authors of a questionnaire for electronic handbooks and tutorial software can only guess what questions might be posed, and do not receive any feedback from the users as to whether and how the wording of the questions might possibly be improved, in particular as regards drivers who are fairly unfamiliar with automobile terminology.

### SUMMARY

The object of the disclosure is to make it easier for a user of a motor vehicle to understand and use features and functions of the vehicle, and hence make the vehicle easier to operate, in order to improve the relationship of the user with the vehicle.

According to the disclosure, the user is offered by the electronic device a catalogue of guided driving tutorials. A guided driving tutorial subsequently selected by the user consists of a sequence of instructions to the user to pay attention to certain vehicle responses and/or to perform certain operating actions or driving maneuvers, and to pay attention to the corresponding response made by the vehicle or by vehicle components. This means that guidance through the driving tutorial is given during a journey although not necessarily only when the vehicle is moving, but possibly also in temporary stationary periods, e.g. waiting at traffic lights.

The user is preferably offered software that can be operated on the electronic device and downloaded from a remote platform, and that contains the catalogue of guided driving tutorials and performs a guided driving tutorial selected by the user.

The guided driving tutorials offered can be adapted using data about the actual equipment fitted in the vehicle, with the user being offered only those driving instructions that can be performed by the actual equipment fitted in the vehicle.

Automatically obtained data about the current manner of use of the vehicle can be used to adapt or restrict the guided driving tutorials offered, with the user being offered only those driving tutorials that are compatible with the current manner of use of the vehicle, e.g. with city traffic, daily short journeys, etc.

Automatically obtained data about the current location of the vehicle and/or the general traffic situation at the location of the vehicle can be used to adapt or restrict the guided driving tutorials offered.

The electronic device is preferably a mobile terminal, in particular a smartphone of the user, but can also be or include an infotainment system of the vehicle.

The disclosure brings vehicle owners closer to their vehicle by offering them a simple, interactive and personalized way of learning and understanding features and functions implemented in their vehicle or even of understanding the behavior of their vehicle.

The instructions can be given to the user visually, acoustically and/or haptically.

Users are preferably given the opportunity to provide personalized feedback on their driving tutorials. For this purpose, reactions of users to instructions given are sent to a remote platform, where computer-aided analysis of these reactions is subsequently performed as to whether the user has understood the instructions correctly. It is thereby possible to improve instructions and questionnaires by degrees, for instance in terms of the information density, and also to tailor instructions and questionnaires to specific users or groups of users.

The guided driving tutorials offered are preferably adapted to the reactions of the user, for instance by setting timers or by repeating instructions if the user has not managed an instructed operating action or a maneuver.

Further improvements and additional analysis options are obtained if after finishing a guided driving tutorial, the user is presented with a questionnaire containing questions that relate directly to the guided driving tutorial taken, to prevent the questionnaire becoming unnecessarily long. The answers from the user are sent to a remote platform, where they are analyzed.

The questions posed can depend on the reaction of the user, e.g. on answer times or mistake rates. The questions can be posed by a voice recognition system and generally can depend on data about the current manner of use of the vehicle and/or the current location of the vehicle.

It can be advantageous to offer or perform guided driving tutorials only under certain conditions, which include certain traffic conditions (e.g. no traffic jam), certain visual conditions (e.g. weather and time of day) and certain conditions in the surroundings (e.g. city traffic).

The method should only be performed when the user actively agrees to it and/or actively starts the method. At the start of a journey, the system can present the user with suggestions for the type of the guided driving tutorial, possibly depending on the vehicle location, the manner of use of the vehicle, the driving history, the vehicle equipment, etc.

The method can be performed using what is known as an avatar, which gives the instructions belonging to the guided driving tutorials, and coordinates the communication with the electronic device. The avatar can be created or customized by the user.

The method preferably includes rewarding a user who has fully or partly completed the guided driving tutorial with bonus points, which can be redeemed with the manufacturer of the vehicle or a vehicle dealer, for instance against merchandising articles or discounts for customer services.

Exemplary embodiments are described below with reference to the drawing, in which the single FIGURE shows an overview of a system for guided driving tutorials.

### BRIEF DESCRIPTION OF THE DRAWINGS

FIG. 1 shows an overview of a system for guided driving tutorials.

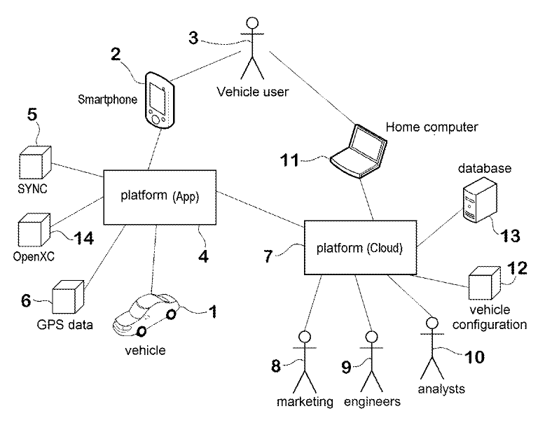

### DETAILED DESCRIPTION

As required, detailed embodiments of the present disclosure are disclosed herein; however, it is to be understood that the disclosed embodiments are merely exemplary of the disclosure that may be embodied in various and alternative forms. The FIGURE is not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

The system and method described below for guided driving tutorials can be implemented using any electronic device installed in a motor vehicle 1 or any portable electronic device located therein, although it is preferably implemented as application software, what is known as an application or app for short, mobile terminals such as, for example, a smartphone 2. In particular, the motor vehicle 1 may be a car.

A vehicle user 3, who is sitting in the motor vehicle 1 with his smartphone 2, can use the app to access a catalogue of “guided driving tutorials”, which match the actual equipment fitted in the vehicle, or are adapted thereto, for instance by reading the vehicle configuration, or can be adapted to the manner of use of the vehicle, for example driving in the city, driving using cruise control, name of the user etc., if this information is available with agreement of the user.

The vehicle user 3 can download to his smartphone 2 a guided driving tutorial from the catalogue from a platform 4 of the vehicle manufacturer, which platform 4 is known as an app store. The apps for guided driving tutorials, which apps are stored on the platform 4, can be developed, for instance, via an open source interface 14 such as MyApp or OpenXC.

A guided driving tutorial comprises the following elements and stages:

Description and classification of the guided driving tutorial (What is it about? What will the driver learn? What type of reward can be offered to the driver taking the driving tutorial? How long is it expected to take? . . . )

Instructions for implementation:

Specific initialization instructions

Specific feature activation instructions (in order to learn about specific functions and capabilities of features), which also include instructions for performing specific operating actions or driving maneuvers

Specific initialization instructions

Specific termination instructions

An optional questionnaire at the end of the guided driving tutorial, to be completed or answered at the end of the journey.

All three elements above are ideally provided to the vehicle user via what is known as an infotainment system 5 (e.g. such as the SYNC system provided by Ford Motor Company), which combines the display and operation of e.g. car radio, navigation system, instruments, displays and/or head-up displays, haptic actuators etc. (not shown). All types of instructions can thereby be given acoustically, visually and/or haptically.

By following the short instructions given during the guided driving tutorial, the driver can find out the features, functions, behavior, capabilities etc. of his vehicle and gain experience. The system can be designed to analyze driver reactions in a suitable manner, for instance to wait until the driver has given the expected reaction such as pressing a button, and operating a pedal or a gear shift, for example.

The infotainment system 5 can work through the questionnaire using voice communication between the system for guided driver tutorials and the driver. The answer could be recorded with agreement of the driver and/or interpreted directly by any voice recognition algorithms.

The questionnaire should focus on the content of the guided driving tutorial, can also be adapted to how the driver performs the guided driving tutorial, and if the driver can give the expected answer directly. Thus, the people who write the questionnaire should also be involved in designing the guided driving tutorial. They should also have the opportunity to furnish any advice or special comments during the instructions, for instance “please slow down now” or “please listen to the engine sound”, etc., if the questionnaire contains specific questions relating to the perceptions of the driver.

Taking a guided driving tutorial and answering the questionnaire should be time-limited and designed so as not to distract the driver. Traffic density and GPS coordinates 6 of the vehicle 1 can be taken into account for this purpose, in order to delay or prevent activation of the guided driving tutorial when the traffic 6 is too dense. Alternatively, the driver can be asked to deactivate the guided driving tutorial when certain conditions are met, for instance when there is no vehicle 1 in view in front on a freeway.

In order to improve driver involvement further, a reward system can be included that credits the driver who has fully or partly completed the guided driving tutorial with a number of bonus points, with additional bonus points being awarded for answering the questionnaire. The bonus points can be vouchers that the driver can redeem at his vehicle dealer, merchandising articles, discounts for customer services by the vehicle dealer or vehicle manufacturer, attendance at special events at test tracks, etc.

In a development, the guided training experience could be presented to the driver as a software-generated simulated person, namely as an avatar, which is downloaded to the infotainment system of the vehicle and which coordinates the guided driving tutorial by supporting the driver, interacting with the driver, talking to the driver, etc., and then sends back the results of the guided driving tutorial to the smartphone of the user.

In addition, guided driving tutorials could be used internally by vehicle manufacturers to perform acceptance tests and some validation and verification tests on the same basis as the customer-oriented guided driving tutorials. For this purpose, the platform 4 can be connected to a cloud or another platform 7 of the vehicle manufacturer, which can be accessed, for instance, by marketing people 8, engineers 9 and analysts 10 at the vehicle manufacturer, possibly also by vehicle users 3 via their home computers 11. The platform 7 receives vehicle configuration data 12 and is connected to a database 13 of the vehicle manufacturer, to which it returns the results of the guided driving tutorial, for instance to perform pass/fail analyses. The guided driving tutorials thus have the added benefit that they can be used by automobile engineers for validations and verifications, in which in addition to, or instead of, the questionnaire, a driving analysis is carried out and translated into pass/fail criteria.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method of teaching a vehicle user about functions of a vehicle, comprising:
offering, via an electronic device, a catalogue of guided driving tutorials, each of the guided driving tutorials includes a sequence of instructions that require attention to certain vehicle responses; and
performing operating actions or driving maneuvers that require paying attention to a corresponding response made by the vehicle or vehicle components of the operating actions or driving maneuvers.

2. The method as claimed in claim 1 further comprising downloading, from a remote platform, the catalogue of guided driving tutorials.

3. The method as claimed in claim 1 further comprising adapting the guided driving tutorials using data about vehicle equipment such that only those driving instructions that can be performed by the vehicle equipment are offered.

4. The method as claimed in claim 1 further comprising automatically obtaining data of vehicle use.

5. The method as claimed in claim 4, further comprising adapting the guided driving tutorials such that only driving tutorials that are compatible with the vehicle use is offered.

6. The method as claimed in claim 1 further comprising automatically obtaining data about a current vehicle location and a general traffic situation at the vehicle location.

7. The method as claimed in claim 6 further comprising adapting the guided driving tutorials based on the general traffic situation.

8. The method as claimed in claim 1, wherein the electronic device is a user mobile terminal.

9. The method as claimed in claim 1, wherein the electronic device is an infotainment system.

10. The method as claimed in claim 1, wherein the sequence of instructions is offered visually, acoustically and/or haptically.

11. The method as claimed in claim 1 further comprising sending user reactions to the sequence of instructions to a remote platform, wherein computer-aided analysis of the user reactions is subsequently performed.

12. The method as claimed in claim 11 further comprising adapting the guided driving tutorials based on the sequence of reactions.

13. The method as claimed in claim 1 further comprising, in response to finishing the guided driving tutorial, presenting a questionnaire containing questions that relate directly to the guided driving tutorial, and sending answers to a remote platform.

14. The method as claimed in claim 1, wherein offering the guided driving tutorials occurs under certain conditions being traffic and visual conditions.

15. The method as claimed in claim 1 further comprising using an avatar to provide the sequence of instructions for the guided driving tutorials, and to coordinate communication with the electronic device.

16. The method as claimed in claim 1 further comprising rewarding full or partial completion of the guided driving tutorials with points.

17. A vehicle infotainment system comprising:
an electronic device configured to, in response to an offered catalogue of guided driving tutorials, each of the guided driving tutorials including a sequence of instructions, perform operating actions or driving maneuvers that require paying attention to a corresponding response made by the vehicle or vehicle components of the operating actions or driving maneuvers.

18. The vehicle infotainment system as claimed in claim 17, wherein the electronic device is further configured to use an avatar to provide the sequence of instructions for the guided driving tutorials, and to coordinate communication with the electronic device.

19. A vehicle comprising:
an infotainment system having an electronic device, the electronic device being configured to, in response to downloading, from a remote platform, a catalogue of guided driving tutorials and offering the catalogue of guided driving tutorials, each of the guided driving tutorials including a sequence of instructions, perform operating actions or driving maneuvers that require paying attention to a corresponding response made by the vehicle or vehicle components of the operating actions or driving maneuvers, and adapt the guided driving tutorials based on a general traffic situation.

20. The vehicle as claimed in claim 19, wherein the electronic device is further configured to send user reactions to the sequence of instructions to the remote platform, wherein computer-aided analysis of the user reactions is subsequently performed.
